(19) United States
(12) Patent Application Publication
(10) Pub. No.: US 2023/0286095 A1
(43) Pub. Date: Sep. 14, 2023

(54) 4-AXIS CNC MACHINE

(71) Applicant: Team Industrial Services, Inc., Sugar Land, TX (US)

(72) Inventors: Leen DE RIDDDER, Sugar Land, TX (US); Mark COLQUITT, Sugar Land, TX (US)

(21) Appl. No.: 18/018,228

(22) PCT Filed: Aug. 3, 2021
(86) PCT No.: PCT/US2021/044322

§ 371 Date: Jan. 26, 2023

Related U.S. Application Data
(60) Provisional application No. 63/060,296, filed on Aug. 3, 2020.

(51) Int. Cl. B23Q 9/00; B24B 23/00; B23C 1/20; B23Q 9/02; B23C 1/00; B23C 1/12

(52) U.S. Cl. CPC B23Q 9/0028; B23C 1/007; B23C 1/12; B23C 1/20; B23Q 9/02; B24B 23/00

(57) ABSTRACT

A portable computer numerical control (CNC) machine is described. The CNC machine has an X-axis, a Y-axis, and a Z-axis, and comprises: a machine head, a base comprising a pair of X-axis guiding rails; a connecting beam and at least one Y-axis guide rail; a sub-assembly having a platform and at least one Z-axis guide rail on the platform; and a tool assembly secured to the platform of the sub-assembly, as well as corresponding X-Axis, Y-Axis and Z-axis clamps to allow the machine head to move along the X, Y, Z axes. The tool assembly of the CNC machine further allows the machine head to rotate about an axis that is perpendicular to the Z-axis.

### PRIOR RELATED APPLICATIONS

This application claims priority to US Serial No. 63/060,296, filed Aug. 3, 2020, and incorporated by reference in its entirety for all purposes.

### FIELD OF INVENTION

In general, this invention relates to portable computer numerical control (CNC) machines for performing field machine services, and more particularly to a portable CNC machine that have four axes to allow processing on different angles and surfaces of an object.

### BACKGROUND OF INVENTION

CNC or Computer Numerical Control machines have been used for decades to automate machining operations such as moving a tool or workpiece in relation to each other in a three-dimensional space to perform operations on the workpiece. The CNC machine is computer controlled with the computer issuing commands controlling the tool path, speed, rotation, etc. A typical CNC machine is a complex, stationary machine located in a workshop and not suitable for addressing machining needs in the field.

There is needed a portable, 4-axis CNC machine adapted for field machining applications.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limited the scope of the claimed subject matter.

An embodiment of the present disclosure provides a portable CNC machine having an X-axis, a Y-axis, and a Z-axis, the CNC machine comprising: a machine head, a base comprising a pair of guiding rails enabling the machine head to move along the X-axis of the CNC machine; a connecting beam having guide rails enabling the machine head to move along the Y-axis of the CNC machine; a sub-assembly with guide rails enabling the machine head to move along the Z-axis of the CNC machine; and a tool assembly secured to the Z-axis that enables the machine head to move in an A-axis.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIGS. 1 and 2 illustrate an embodiment of the 4-axis CNC machine of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

A computer numerical control (CNC) system requires motor drives to control both the position and the velocity of machine axes. Each axis must be driven separately, and must follow the command signal generated by the numerical control. Generally, there are two ways to activate the servo drives: the open-loop system and the closed-loop system.

In an open-loop CNC system, programmed instructions are fed into the controller through an input device. These instructions are then converted to electrical signals by the controller and sent to the servo amplifier to drive the servo motors. The cumulative number of electrical pulses determines the distance each servo drive will move, and the signal frequency determines the velocity of movement. The primary characteristic of the open-loop system is that there is no feedback system to check whether the desired position and velocity has been achieved. If system performance has been affected by load, temperature, humidity, or lubrication, then the actual output could deviate from that desired. For these reasons, the open-loop CNC system is generally used in point-to-point systems where accuracy is not critical. Very few continuous-path systems utilize open-loop control.

The closed-loop CNC system has a feedback subsystem to monitor the actual output and correct any discrepancy from the programmed input. This can be either analog or digital. Analog systems measure the variation of physical variables, such as position and velocity, as voltages. Digital systems monitor output variations by means of electrical pulses. Closed-loop systems are very powerful and accurate because they are capable of monitoring operating conditions through feedback subsystems and can compensate for any variations automatically in real time. Most modern closed-loop CNC systems are able to provide very close resolution of 0.0001 of an inch. Closed-looped systems would require more control devices and circuitry in order to implement both position and velocity control, and therefore more complex and more expensive than open-loop systems.

Motion control is the key to any CNC systems. The most basic function of any CNC machine is automatic, precise, and consistent motion control. Rather than applying completely mechanical devices to cause motion as is required on most conventional machine tools, CNC machines allow automatic movement on two or more axes. The two most common axis types are linear (driven along a straight path) and rotary (driven along a circular path).

Instead of causing motion by turning cranks and handwheels as is required on conventional machine tools, CNC machines allow motions to be commanded through programmed commands. Generally speaking, the motion type (rapid, linear, and circular), the axis to move, the amount of motion and the motion rate (federate) are programmable.

Accurate positioning is accomplished by the operator counting the number of revolutions made on the handwheel plus the graduation on the dial. The drive motor is rotated a corresponding amount, which in turn drives the ball screw, causing linear motion of the axis. A feedback device (such as in a closed-looped system) confirms that the proper amount of the ball screw revolutions have occurred. A CNC command executed within the control (through a program) ells the drive motor to rotate a precise number of times. The rotation of the drive motor in turn rotates the ball screw, which drives the linear axis. The feedback device at the opposite end of the ball screw allows the control to confirm that the commanded number of rotations has taken place.

The axis motion can be commanded by utilizing certain types of coordinate system, such as the rectangular coordinate system and the polar coordinate system, and the rectangular coordinate system is the most popular one. To utilize the rectangular coordinate system, the CNC programmer is going to be plotting physical end points for axis motions. Each linear axis of the machine tool can be considered as a base line of the graph. Like graph base lines, axes are broken into increments, and a CNC machine’s rectangular coordinate system is broken into increments of measurement. In the inch mode, the smallest increment is usually 0.0001 inch. In the metric mode, the smallest increment is 0.001 millimeter. Similarly, for rotary axes the increment is typically 0.001 degrees.

Just like the x-y plotting, the place where the horizontal baseline and the vertical baseline come together is called the original point of the graph (“program zero point” or “program origin”). The only difference between the rectangular coordinate system and the x-y plotting is that program origin can be applied to any axis. The program zero point establishes the point of reference for motion commands in a CNC program. This allows the programmer to specify movements from a common location. With this technique, if the programmer wishes the tool to be sent to a position one inch to the right of the program zero point, X1.0 is commanded. If the programmer wishes the tool to move to a position one inch above the program zero point, Y1.0 is commanded. The control will automatically determine how many times to rotate each axis drive motor and ball screw to make the axis reach the commanded destination point. This lets the programmer command axis motion in a logical manner.

The CNC machine tool has programmable motion directions (axes), whose names may vary from one machine tool type to the next. Common axis names are X, Y, Z, U, V, and W for linear axes and A, C, and C for rotary axes.

In general, the present disclosure relates to a 4 axis CNC portable machine similar to a workshop multi-axis milling machine. The present disclosure represents a portable solution enabling the machining of equipment on location. The present disclosure is particularly advantageous when equipment cannot be transported easily or when efficiency requires machining on-site versus transporting the equipment to the workshop and then having to transport back to location after machining.

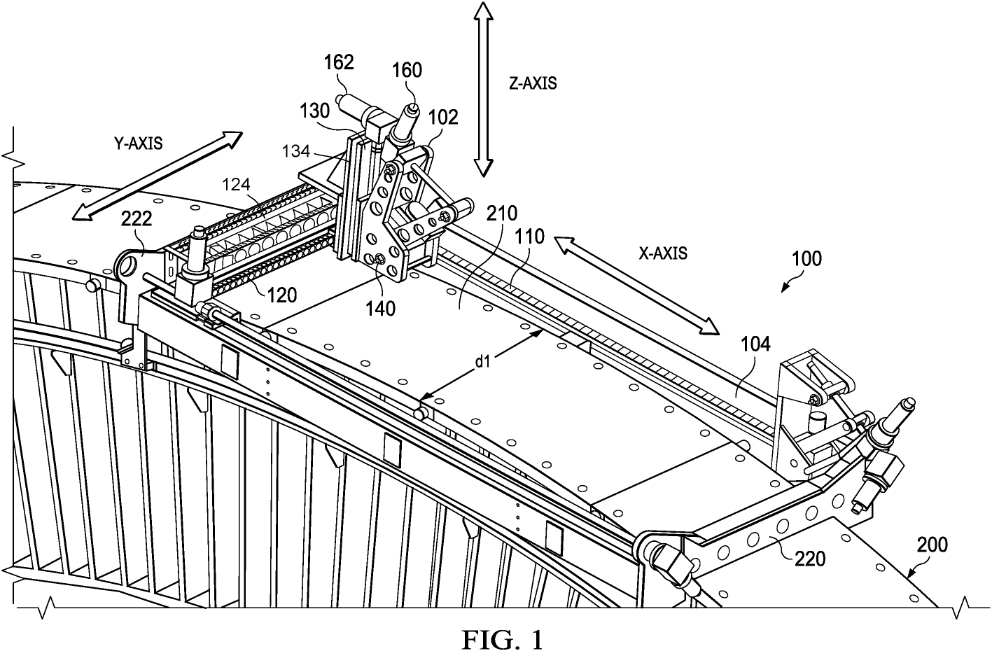

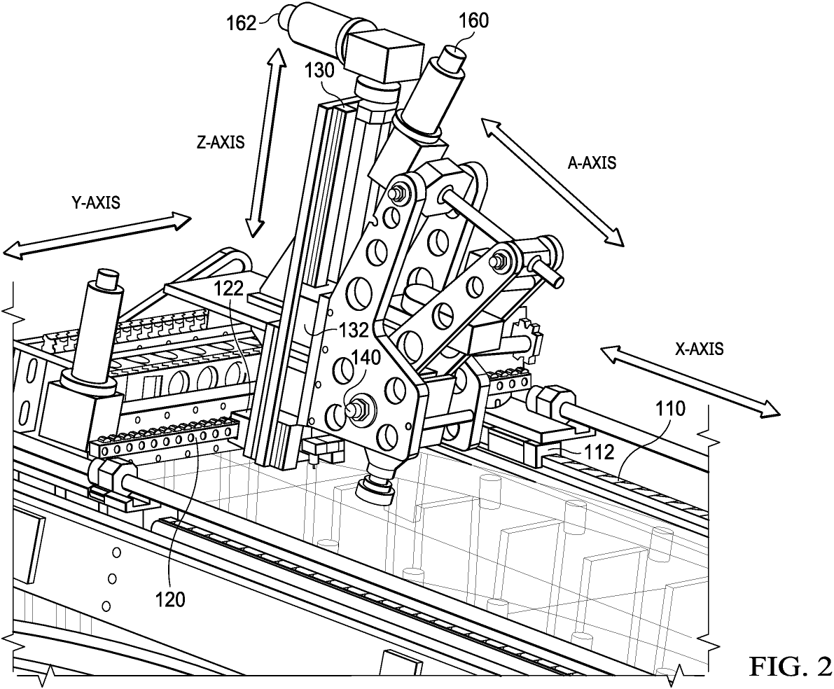

As illustrated in FIGS. 1 and 2, the machine of the present disclosure comprises a machine head assembly 100 that is mounted on a top surface 210 of an object of interest 200. The adjustable mounts or clamps 220, 222 allow an operator to securely mount the machine head assembly 100 by adjusting its mounting width to match the width d1 of the object of interest 200. Once securely mounted, the machine head 102 can move along 3 primary X, Y & Z axes, as well as rotating in the angular axis A. After the machining is completed, the operator can easily dismount the entire machine head assembly 100 from the object of interest, and move on to the next object of interest. The added fourth axis allows for more versatile machining as well as more flexibility in angles and/or distances.

More specifically, the machine head assembly 100 comprises a base 104 that comprises a pair of X-axis guide rails 110 and a corresponding X-axis clamp 112 to alone the machine head 102 to move along the X-axis as needed. The machine head assembly 100 further comprises a connecting beam 124 and a Y-axis guide rail 120, as well as a corresponding Y-axis clamp 122 to allow the machine head 102 to move along the Y-axis as needed. The machine head assembly 100 further comprises a baseplate 134 and a Z-axis guide rail 130 located on the base plate 134, as well as a corresponding Z-axis clamp 132 to allow the machine head 102 to move along the Z-axis as needed.

Additionally, the machine head assembly 100 further comprises a tool assembly 140 that on the Z-axis baseplate 134. The tool assembly 140 can rotate about an pivot or hinge that is perpendicular to the Z-axis to allow an operator to rotate the machine head 102 and adjust its angular position along the A-axis.

Adjustors 160, 162 are also provided to manually adjust the position and/or tightness of the machine head 102 along the X, Y, Z or A axes. Additional tools can also be added to the machine head assembly 100.

The portable CNC machine of the present disclosure enables machining work on an external curved surface, although it is not restricted to only curved surfaces and can be used on other profiles/shapes/internal & external. The portable machine base will be mounted to the work piece and the 3 main primary axes will allow the machine head 110 to traverse as required. For this application the fourth axis enables the machine head 110 to be rotated to suit the curvature of the surface 210 of the object of interest 200 and achieve a smooth machined surface. The benefit of the fourth axis is that the machine head 110 can be positioned such that the various machine tools (not shown) are perpendicular and/or at a varying angle to the surface as required by the application. This allows a number of machine applications to be undertaken, such as drilling, sanding, cutting, polishing or tapping, to suit the application.

With the portable CNC machine of this disclosure, an operator or programmer can readily move the portable CNC machine to a different location, mount the portable CNC machine on an object of interest to be processed, and program the movement and process of the machine head along the X, Y, Z and A axes with accuracy. It also increases the flexibility of an operator’s choice of tool, as the adjustable angles of the machine head allows the tools to contact the object of interest at different angles and distances.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded. In the claims, means-plus-function clauses are intended to cover the structures described herein as performing the recited function and not only structural equivalents, but also equivalent structures. It is the express intention of the applicant not to invoke 35 U.S.C. § 112, paragraph 6 for any limitations of any of the claims herein, except for those in which the claim expressly uses the words “means for” together with an associated function.

What is claimed is:

1. A portable computer numerical control (CNC) machine having an X-axis, a Y-axis, and a Z-axis, the CNC machine comprising:
a) a machine head,
b) a base comprising a pair of X-axis guiding rails;
c) a connecting beam and at least one Y-axis guide rail;
d) a sub-assembly having a platform and at least one Z-axis guide rail on the platform; and
e) a tool assembly secured to the platform of the sub-assembly,
wherein the machine head further comprising a X-axis clamp corresponding to the X-axis guide rails to allow the machine head to move along the X-axis of the CNC machine;
wherein the machine head further comprising a Y-axis clamp corresponding to the Y-axis guide rail to allow the machine head to move along the Y-axis of the CNC machine;
wherein the machine head further comprising a Z-axis clamp corresponding to the Z-axis guide rail to allow the machine head to move along the Z-axis of the CNC machine; and
wherein the tool assembly further comprising a rotating mechanism to allow the machine head to rotate about an axis perpendicular to the Z-axis.

2. The portable CNC machine of claim 1, further comprising:
f) a mounting mechanism located on the base, wherein the mounting mechanism is adjustable in width to securely mount the CNC machine on a surface.

3. The portable CNC machine of claim 1, further comprises tool mounting adjustor to mount a tool on the CNC machine.

4. The portable CNC machine of claim 3, wherein the tool is a drilling tool.

5. The portable CNC machine of claim 3, wherein the tool is a sanding tool.

6. The portable CNC machine of claim 3, wherein the tool is a tapping tool.

7. The portable CNC machine of claim 3, wherein the tool is a polishing tool.

8. The portable CNC machine of claim 3, wherein the tool is a cutting tool.

9. The portable CNC machine of claim 1, wherein the movement, speed, location and angle of the machine head is controlled by a computer.
